(19) United States
(12) Patent Application Publication
(10) Pub. No.: US 2011/0003579 A1
(43) Pub. Date: Jan. 6, 2011

(54) ONLINE CHARGING FOR SUPPLEMENTARY SERVICES IN IMS NETWORKS

(76) Inventors: Yigang Cai, Naperville, IL (US); Xiangyang Li, Beijing (CN)

Correspondence Address: DUFT BORNSEN & FISHMAN, LLP, 1526 SPRUCE STREET, SUITE 302, BOULDER, CO, 80302, US

(21) Appl. No.: 12/865,998

(22) PCT Filed: Feb. 26, 2008
(86) PCT No.: PCT/US08/54988

§ 371 Date: Aug. 3, 2010

(51) Int. Cl. H04M 11/08

(52) U.S. Cl. 455/408

(57) ABSTRACT

IMS networks and methods are disclosed for providing online charging for supplementary services for a session. The IMS network includes an application server operable to provide at least one supplementary service for a session. When the supplementary service is to be provided, the session is routed to the application server. The application server then provides the supplementary service and also provides charging for the service. To provide charging, the application server generates one or more charging request messages for the supplementary service, and transmits the charging request message for the supplementary service to an online charging system (OCS) of the IMS network. The OCS processes the charging request message accordingly to provide charging for the supplementary service in addition to the session.

### BACKGROUND OF THE INVENTION

1. Field of the Invention

The invention is related to the field of IMS networks, and in particular, to performing online charging for supplementary services provided for a session in IMS networks.

2. Statement of the Problem

Network operators are implementing IP Multimedia Subsystem (IMS) networks as a common core network to provide multimedia services to IMS users over an Internet Protocol (IP) network. IMS networks were originally designed by the 3^{rd} Generation Partnership Project (3GPP), and later 3GPP2. Through a properly enabled IMS device (also referred to as IMS User Equipment (UE)), an IMS user may establish a session over the IMS network. To establish the session, signaling messages (i.e., SIP messages) are exchanged to set up a bearer connection, which is typically Real-time Transport Protocol (RTP). The bearer data (i.e., the voice conversation) may then be exchanged between the parties to the session.

In additional to sessions, the IMS network is adapted to provide supplementary services for the session, much like supplementary services are available to users of a PSTN. Supplementary services are a comprehensive set of services that complement and support telephony-type voice sessions or data sessions. For example, supplementary services may include Originating Identification Presentation (OIP), Originating Identification Restriction (OIR), Terminating Identification Presentation (TIP), Terminating Identification Restriction (TIR), Communication Diversion (CDIV), Communication Hold (HOLD), Communication Barring (CB), Message Waiting Indication (MWI), Conference (CONF), Explicit Communication Transfer (ECT), etc.

The 3GPP has also defined a charging architecture for the IMS networks that includes an offline charging system and an online charging system. The offline charging system provides postpaid charging, meaning that the services are provided first and the IMS user is billed later. The online charging system (OCS) provides prepaid charging, meaning that the IMS user has to have an account balance prior to services being provided, and the account balance is debited as the services are provided.

The OCS includes an online charging function, an account balance management function (ABMF), and a rating function (RF). The ABMF maintains an amount of service units in an account of an IMS user. The rating function determines the cost of service usage according to a tariff defined by the network operator. The online charging function utilizes the ABMF and the rating function in order to perform online charging.

The service elements in the IMS network, such as a Proxy-Call Session Control Function (P-CSCF), a Session-Call Session Control Function (S-CSCF), an application server (AS), include Charging Trigger Functions (CTF). These CTFs are adapted to monitor service usage and to generate charging messages responsive to charging events. The CTFs then transmit the charging messages to the OCS to provide online charging for the service usage.

Online charging may be performed as direct debiting or unit reservation. For direct debiting, the online charging function debits the units immediately from the account of the IMS user for an individual transaction. For unit reservation, the online charging function grants a quota of units from the account of the IMS user, and provides the quota of units to the requesting service element. The requesting service element then performs budget control by monitoring service usage and deducting from the quota accordingly. If the quota of units expires, then the service element requests another quota of units, and the process continues. After the service has terminated, the total amount of units to deduct from the IMS user's account is resolved.

The following illustrates an example of charging for a session in an IMS network. An IMS user either initiates or is invited to receive a session through the appropriate signaling message, such as a SIP INVITE message. An S-CSCF is assigned to the IMS user to manage the session, so the signaling message goes through the S-CSCF. Responsive to receiving the signaling message for the IMS user, the S-CSCF contacts a Home Subscriber Server (HSS) to access the subscriber profile for the IMS user. The subscriber profile, among other things, indicates the level of service subscribed to by the IMS user, any supplementary services subscribed to by the user, etc. The subscriber profile also indicates that the IMS user is a prepaid user. Thus, responsive to the detecting the start of the session, a CTF in the S-CSCF (or in an IMS gateway as suggested by some of the 3GPP technical specifications) initiates online charging for the session. To initiate online charging, the CTF generates a Diameter Ro Credit Control Request (CCR) [INITIAL] message indicating the start of the session, and transmits the CCR [INITIAL] message to the OCS.

The online charging function in the OCS then processes information in the CCR [INITIAL] message to identify the IMS user, to determine the media type for the session, etc, and accesses the rating function with this and other information to determine a rating for the session. The online charging function also accesses the ABMF to determine whether the IMS user has a sufficient account balance to initiate the session, and if so, to determine how many service units to grant for the session. The online charging function then generates a Credit Control Answer (CCA) [INITIAL] message, and transmits the CCA [INITIAL] message to the S-CSCF. The CCA [INITIAL] message indicates that the session is allowed, and also indicates the number of quota granted for the session.

The S-CSCF (or the IMS gateway) receives the CCA [INITIAL] message, and performs budget control. For budget control, the S-CSCF identifies the quota of service units, and decrements the quota as the session continues. If the CTF in the S-CSCF identifies another charging event, then the S-CSCF generates a CCR [UPDATE] message. For example, a charging event may comprise receiving a SIP 200 OK message acknowledging a SIP INVITE, a RE-INVITE, or an UPDATE message, may comprise the expiration of the quota of service units, may comprise the expiration of a validity timer, etc. The S-CSCF transmits the CCR [UPDATE] message to the OCS. The online charging function performs similar processes to grant another quota of service units (if available) for the session, generates a CCA [UPDATE] message, and transmits the CCA [UPDATE] message to the S-CSCF. The CCA [UPDATE] message indicates that the session is allowed to continue, and also indicates the additional quota of service units granted for the session.

The S-CSCF (or the IMS gateway) receives the CCA [UPDATE] message, and again performs budget control on the newly granted quota. Assume at some later time that the session ends. Responsive to identifying the end of the session, the CTF in the S-CSCF generates a CCR [TERMINATION] message, and transmits the CCR [TERMINATION] message to the OCS. The CCR [TERMINATION] message indicates the number of service units used for the session (either for duration of the session or for the latest slice of the quota granted by the online charging function). The online charging function then resolves the total debit for the session from the account of the IMS user in the ABMF.

During the session of the IMS user, one or more supplementary services may be invoked. To invoke a supplementary service, the S-CSCF routes the session to an application server, such as Telephony Application Server (TAS), that is adapted to provide the supplementary service. For instance, the S-CSCF may transmit a SIP INVITE message to the application server to route the session to the application server. The application server then provides the supplementary service for the session, and routes the session back to the S-CSCF.

One problem with present IMS online charging is that the supplementary services are not charged individually. If the IMS user subscribes to a prepaid plan that includes one or more supplementary services, the tariff defined by the network operator may vary based on which supplementary services are selected by the IMS user. For instance, if more supplementary services are selected by the IMS user, there may be a higher tariff defined by the network operator for that IMS user. Thus, when the IMS user is involved in a session, the session is being charged at the higher tariff according to the supplementary services selected. If one or more supplementary services are provided during the session by an application server, these supplementary services are not charged individually but are just part of the overall charge for the session. Network operators may unfortunately be losing significant revenues by not charging for the supplementary services individually.

### SUMMARY OF THE SOLUTION

Embodiments of the invention solve the above and other related problems by providing functionality for charging for supplementary services in an IMS network separately from the session. When an application server provides a supplementary service for the session, the application server generates a charging request message, such as a Diameter Credit Control Request (CCR) message, and transmits the charging request message to the OCS. The OCS will then provide online charging for the supplementary service, much like is performed for the session, but the OCS will correlate the supplementary service with the session using the same IMS charging identifier. Because the application server transmits a charging request message to the OCS responsive to providing the supplementary service, the network operator can effectively charge for the supplementary service individually, and also charge for the session. The network operator may thus realize the revenues of providing the supplementary services.

One embodiment of the invention comprises an IMS network adapted to provide online charging for supplementary services for a session. The IMS network includes an application server operable to provide at least one supplementary service, and a session control system operable to manage a session. When in operation, the session control system receives one or more signaling messages for the session, and identifies a trigger for a supplementary service to provide for the session. The session control system then routes the session to the application server. When the session is routed to the application server, the application server provides the supplementary service. The application server also generates one or more charging request messages for the supplementary service, and transmits the charging request message for the supplementary service to an online charging system (OCS) of the IMS network. The charging request message may be for session-based charging or event-based charging. The OCS processes the charging request message accordingly to provide charging for the supplementary service in addition to the session.

In another embodiment, one or more new AVPs are defined for charging request message, which may be a Diameter Ro message. The application server identifies charging information for the supplementary service, and inserts the charging information for the supplementary service in the AVP(s) of the charging request message.

The invention may include other exemplary embodiments described below.

### DESCRIPTION OF THE DRAWINGS

The same reference number represents the same element or same type of element on all drawings.

FIG. 1 illustrates an IMS network in an exemplary embodiment of the invention.

FIG. 2 is a flow chart illustrating a method of performing online charging for the session in an exemplary embodiment of the invention.

FIG. 3 is a flow chart illustrating a method of performing online charging for a supplementary service in an exemplary embodiment of the invention.

FIG. 4 is a message diagram illustrating an example of Immediate Event service charging (IEC) for a supplementary service in an exemplary embodiment of the invention.

FIG. 5 is a message diagram illustrating an example of Event-based charging with unit reservation (ECUR) for a supplementary service in an exemplary embodiment of the invention.

### DETAILED DESCRIPTION OF THE INVENTION

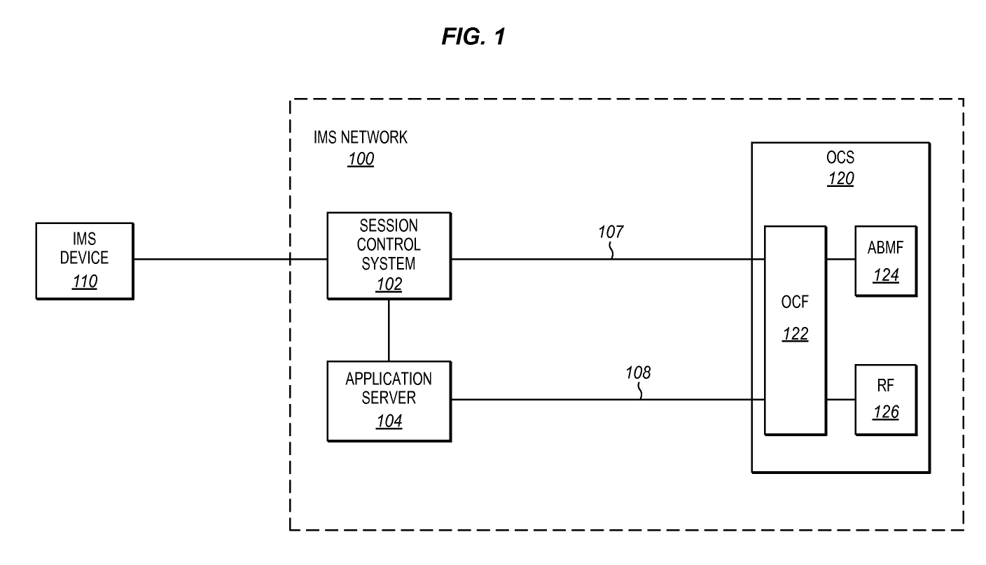

FIGS. 1-5 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an IMS network 100 in an exemplary embodiment of the invention. IMS network 100 includes a session control system 102, an application server 104, and an online charging system (OCS) 120. IMS network 100 may include other service elements, such as an offline charging system, a Home Subscriber Server (HSS), etc., which are not shown in FIG. 1 for the sake of brevity.

Session control system 102 comprises any system, server, or function operable to set up, manage, and/or tear down voice and/or data sessions (i.e., SIP sessions) involving IMS device 110 and other IMS devices (not shown). One example of a session control system 102 is a serving-call session control function (S-CSCF). Those familiar with the 3GPP technical specifications understand that an S-CSCF is presently defined as having an ISC interface towards the OCS 120. Thus, an IMS gateway is introduced between the S-CSCF and OCS 120 to convert ISC messages to Diameter Ro messages toward OCS 120. Session control system 102 may thus encompass an S-CSCF having the appropriate Charging Trigger Function (CTF) and charging interface (i.e., Diameter Ro), or may encompass an S-CSCF along with an IMS gateway as suggested by the 3GPP.

Application server 104 comprises any system, server, or function operable to provide supplementary services for sessions. Supplementary services comprise any set of services that complement and support telephony-type voice sessions or data sessions. For example, forwarding of a session from one directory number to another directory number may be a supplementary service for a session. In another example, a three-way or n-way conference may be a supplementary service for a session. Those skilled in the art will appreciate that application server 104 may provide multiple supplementary services, or there may be multiple application servers providing the different supplementary services.

OCS 120 comprises any system, server, or function operable to provide online charging for a session. According to the embodiments described herein, OCS 120 is further operable to provide online charging for supplementary services provided for a session. In this embodiment, OCS 120 includes an online charging function (OCF) 122, an Account Balance Management Function (ABMF) 124, and a rating function (RF) 126. OCF 122 comprises any system, server, or function operable to manage online charging in OCS 120 by accessing ABMF 124 and RF 126, exchanging charging messages with service elements, such as session control system 102 and application server 104, and performing other functions. ABMF 124 comprises any system, server, or function operable to maintain accounts for IMS users, and more particularly to maintain an amount of service units in the accounts of the IMS users. RF 126 comprises any system, server, or function operable to determine the cost of service usage according to a tariff defined by the network operator.

Session control system 102 is connected to OCS 120 over interface 107. Similarly, application server 104 is connected to OCS 120 over interface 108. Interfaces 107-108 each comprise charging interfaces defined for providing online charging information to OCS 120 for online charging. In this embodiment, interface 108 (and possibly interface 107) comprises a Diameter Ro interface that is enhanced with new Attribute Value Pairs (AVPs) for supplementary services, which are described later in the specification.

IMS device 110 is being operated by an IMS user (not shown). The IMS user has subscribed to a particular service offered by the network operator of IMS network 100. For the service subscription, the IMS user has selected one or more supplementary services to be available for sessions. The supplementary services are recorded in a service profile of the IMS user that is stored in a Home Subscriber Server (HSS) (not shown).

Assume, for example, that the IMS user either initiates or is invited to receive a session over IMS network 100 through the appropriate signaling message, such as a SIP INVITE message. The signaling message is routed to the session control system 102 assigned to the IMS user so that the session control system 102 can manage the session. Responsive to receiving the signaling message for the IMS user, session control system 102 contacts the HSS to access the service profile for the IMS user. The subscriber profile, among other things, indicates the level of service subscribed to by the IMS user, any supplementary services subscribed to by the user, etc. The subscriber profile also indicates that the IMS user is a prepaid user.

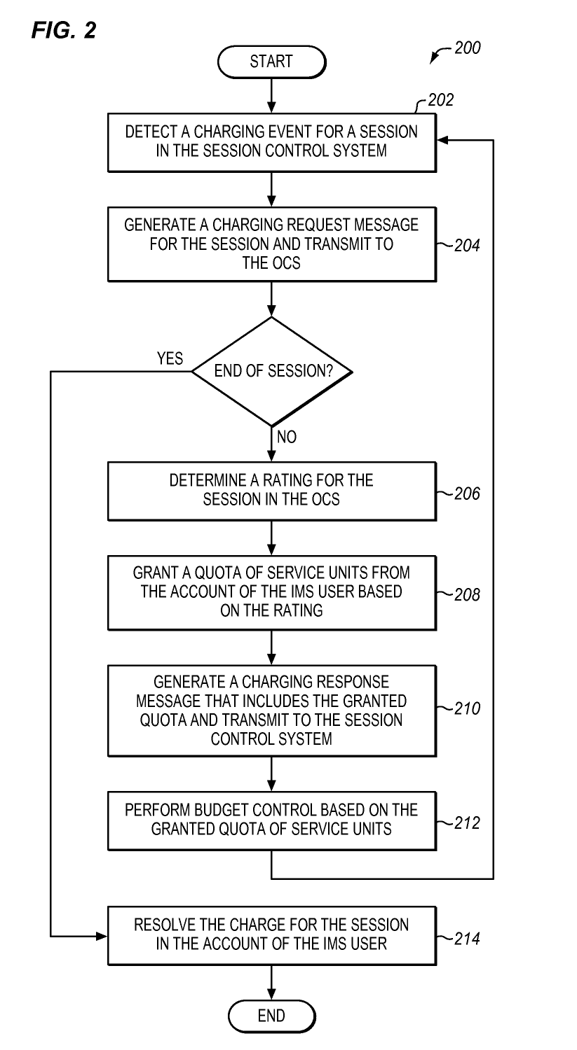

As part of managing the session, session control system 102 implements a Charging Trigger Function (CTF) to provide online charging for the session. FIG. 2 is a flow chart illustrating a method 200 of performing online charging for the session in an exemplary embodiment of the invention. Method 200 describes some basic steps of online charging for the session, but other steps may also be performed as needed or desired.

When the session is initiated, the CTF in the session control system 102 detects a charging event for the session in step 202. The charging event at this time comprises the start of the session, such as the receipt of a SIP INVITE message. In step 204, session control system 102 (or the CTF in session control system 102) generates a charging request message for the session. At the beginning of the session, the charging request message is an “initial” message and indicates the start of the session. One example of an initial charging request message is a Diameter Ro Credit Control Request (CCR) [INITIAL] message. Session control system 102 transmits the charging request message to OCS 120.

The online charging for the session represents session-based charging (with unit reservation (Session-based charging (SBC)) as opposed to event-based charging. With session-based charging, the initial charging request message is requesting authorization to connect the session, and is also requesting a quota of service units from OCS 120 so that budget control may be performed.

The OCF 122 in OCS 120 processes the initial charging request message to identify information for the session, such as the identity of the IMS user, the media type for the session, etc. In step 206, OCF 122 accesses RF 126 with the session information to determine a rating for the session. OCF 122 also accesses ABMF 124 to determine whether the IMS user has a sufficient account balance to initiate the session, and if so, to determine how many service units to grant for the session. In step 208, OCF 126 then grants a quota of service units from the account of the IMS user based on the rating, the account balance, etc. OCF 122 then generates a charging response message that includes the granted quota of service units. The charging response message is an “initial” message and indicates the initial quota granted for the session. One example of an initial charging response message is a Diameter Ro Credit Control Answer (CCA) [INITIAL] message. OCF 122 then transmits the charging response message to session control system 102.

Session control system 102 receives the charging response message from OCS 120 and processes the charging response message to identify the granted quota and any other relevant information. In step 212, session control system 102 performs budget control for the session based on the granted quota of units. For budget control, session control system 102 decrements the quota of service units as the session continues. Method 200 then returns to step 202.

Session control system 102, through its CTF, detects another charging event during the session in step 202. The charging event may comprise receiving a SIP 200 OK message acknowledging a SIP INVITE, a RE-INVITE, or an UPDATE message, may comprise the expiration of the granted quota of service units, may comprise the expiration of a validity timer, etc. Responsive to detecting the charging event, session control system 102 generates another charging request message for the session in step 204. At this point in the session, the charging request message is an “update” message. One example of an update charging request message is a CCR [UPDATE] message. Session control system 102 transmits the charging request message to OCS 120.

The OCF 122 in OCS 120 processes the update charging request message to identify information for the session. In step 206, OCF 122 accesses RF 126 with the session information to determine a rating for the session. This step may not be necessary for an update message, but one or more session description parameters for the session may have changed which may change the rating. OCF 122 also accesses ABMF 124 to determine whether the IMS user has a sufficient account balance to continue the session, and if so, to determine how many service units to grant for the session. In step 208, OCF 126 grants a quota of service units from the account of the IMS user based on the rating, the account balance, etc. OCF 122 then generates a charging response message that includes the granted quota of service units and indicates that the session is allowed to continue. The charging response message is an “update” message and indicates the next quota granted for the session. One example of an update charging response message is a CCA [UPDATE] message. OCF 122 then transmits the charging response message to session control system 102.

Session control system 102 receives the charging response message from OCS 120 and processes the charging response message to identify the granted quota and any other relevant information. In step 212, session control system 102 performs budget control for the session based on the granted quota of units. Method 200 then returns to step 202.

Session control system 102 may detect one or more additional charging events during the session that trigger an update charging request message. At some point however the session will come to an end. In step 202, session control system 102, through its CTF, detects another charging event during the session. The charging event at this time comprises the end of the session, such as the receipt of a SIP END message. In step 204, session control system 102 generates another charging request message for the session. At this point in the session, the charging request message is a “termination” message. One example of a termination charging request message is a CCR [TERMINATION] message. The termination charging request message may include an indication of the total number of service units consumed during the session, or may include an indication of the number of service units remaining from the latest quota. Session control system 102 transmits the charging request message to OCS 120.

Because OCF 122 determines that the session has ended, OCF 122 processes the termination charging request message to identify how many service units were consumed for the session. In step 214, OCF 112 resolves the charge for the session in the account of the IMS user. In resolving the account, the correct amount of units is deducted from the account of the IMS user based on the duration of the session. Method 200 then ends.

During the session of the IMS user described above, one or more supplementary services may be invoked. To invoke a supplementary service, session control system 102 routes the session to application server 104, which is adapted to provide the supplementary service. For instance, session control system 102 may transmit a SIP INVITE message to application server 104 to route the session to application server 104. Application server 104 then provides the supplementary service for the session, and routes the session back to session control system 102.

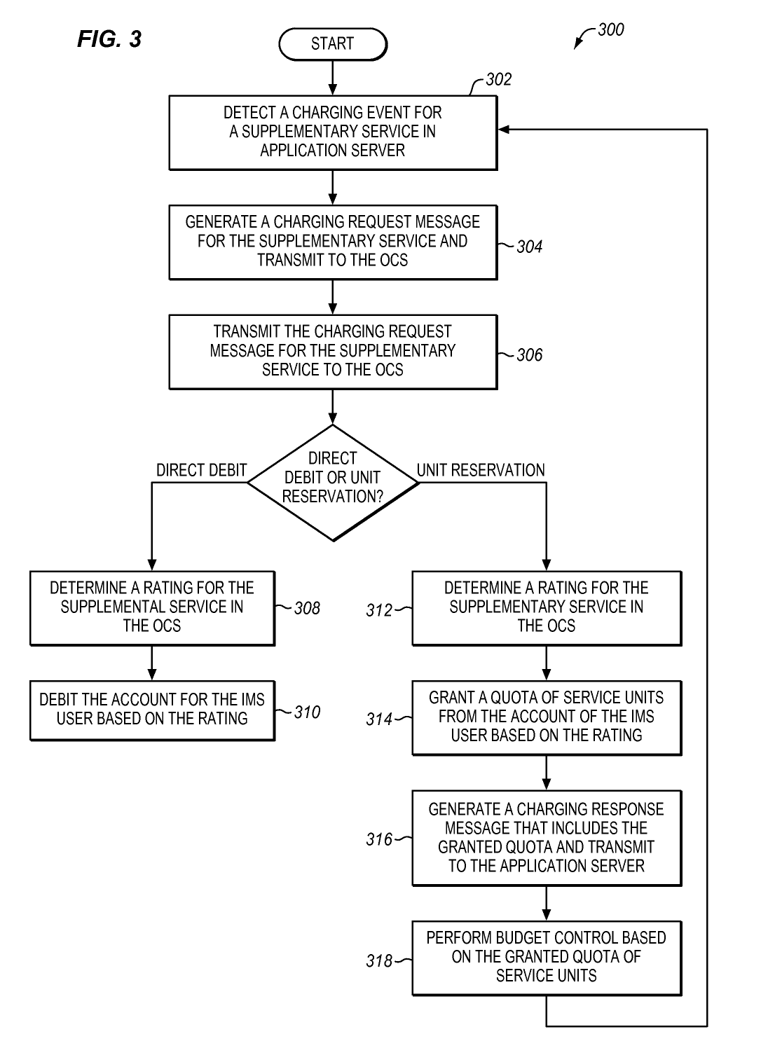

According to the embodiments described herein, the supplementary service or supplementary services are charged independent of the session. FIG. 3 is a flow chart illustrating a method 300 of performing online charging for a supplementary service in an exemplary embodiment of the invention. Method 300 describes some basic steps of online charging for a supplementary service, but other steps may also be performed as needed or desired.

When the session is routed to application server 104, application server 104 provides the supplementary service in step 302. Application server 104 includes a CTF for the supplementary service that is operable to detect charging events when application server 104 provides the supplementary service. In step 304, application server 104 generates a charging request message for the supplementary service. The online charging for the supplementary service may be performed as direct debiting (e.g., Immediate Event service charging (IEC)) or unit reservation (e.g., Session-based charging (SBC) or Event-based charging with unit reservation (ECUR)). For direct debiting, the charging request message requests authorization of the supplementary service, which will be charged as a single transaction. For unit reservation, the charging request message requests authorization of the supplementary service, and requests a quota of service units for the service. In step 306, application server 104 transmits the charging request message for the supplementary service to OCS 120.

OCF 122 receives the charging request message, and determines whether the charging request message is for direct debiting charging or unit reservation charging. If the charging request message is for direct debiting charging, then OCF 122 accesses RF 126 to determine a rating for the supplementary service in step 308. OCF 122 also accesses ABMF 124 to debit the account for the IMS user based on the rating determined for the supplementary service in step 310. OCF 122 will invoke both RF 126 and ABMF 124 in correlating the supplementary service with the session using the same IMS charging identifier. OCF 122 will also transmit a charging response message to application server 104 indicating that the supplementary service is authorized to be provided.

If the charging request message is for unit reservation, then OCF 122 accesses RF 126 to determine a rating for the supplementary service in step 312. The rating may also depend on the session when correlating the supplementary service with the session. In step 314, OCF 122 accesses ABMF 124 to grant a quota of service units based on the rating for the supplementary service. In step 316, OCF 122 generates a charging response message indicating the granted quota of service units for the supplementary service, and also indicating that the supplementary service is authorized to be provided. The charging response message is an “initial” message and indicates the initial quota granted for the supplementary service. One example of an initial charging response message is a Diameter CCA [INITIAL] message. OCF 122 then transmits the charging response message to application server 104.

Application server 104 receives the charging response message from OCS 120, and processes the charging response message to identify the granted quota and any other relevant information. In step 318, application server 104 performs budget control for the supplementary service based on the granted quota of units. For budget control, application server 104 decrements the quota of service units as the supplementary service is provided. Method 300 then returns to step 302. Method 300 will continue much like method 200 while the supplementary service is being provided.

Application server 104, through its CTF, detects another charging event during the supplementary service in step 302. The charging event may comprise the expiration of the granted quota of service units, may comprise the expiration of a validity timer, etc. Responsive to detecting the charging event, application server 104 generates another charging request message for the supplementary service in step 304. At this point, the charging request message is an “update” message. One example of an update charging request message is a CCR [UPDATE] message. Application server 104 transmits the charging request message to OCS 120 in step 306.

The OCF 122 in OCS 120 processes the update charging request message to identify information for the supplementary service. In step 312, OCF 122 accesses RF 126 to determine a rating for the supplementary service. This step may not be necessary for an update message, but something may have changed which may change the rating. OCF 122 also accesses ABMF 124 to determine whether the IMS user has a sufficient account balance to continue the supplementary service, and if so, to determine how many service units to grant for the supplementary service. In step 314, OCF 126 grants a quota of service units from the account of the IMS user based on the rating, the account balance, etc. OCF 122 then generates a charging response message that includes the granted quota of service units, and indicates that the supplementary service is allowed to continue. The charging response message is an “update” message and indicates the next quota granted for the supplementary service. One example of an update charging response message is a CCA [UPDATE] message. OCF 122 then transmits the charging response message to application server 104.

Application server 104 receives the charging response message from OCS 120 and processes the charging response message to identify the granted quota and any other relevant information. In step 318, application server 104 performs budget control for the session based on the granted quota of units. Method 300 then returns to step 302.

Application server 104 may detect one or more additional charging events during the supplementary service that trigger an update charging request message. At some point however the supplementary service will come to an end. In step 302, application server 104, through its CTF, detects another charging event during the supplementary service. The charging event at this time comprises the end of the supplementary service. In step 304, application server 104 generates another charging request message for the supplementary service. At this point in the supplementary service, the charging request message is a “termination” message. One example of a termination charging request message is a CCR [TERMINATION] message. The termination charging request message may include an indication of the total number of service units consumed during the supplementary service, or may include an indication of the number of service units remaining from the latest quota. Application server 104 transmits the charging request message to OCS 120 in step 306.

Because OCF 122 determines that the supplementary service has ended, OCF 122 processes the termination charging request message to identify how many service units were consumed for the supplementary service. As in step 214 of FIG. 2, OCF 122 resolves the charge for the supplementary service in the account of the IMS user. In resolving the account, the correct amount of units is deducted from the account of the IMS user based on the duration of the supplementary service.

In the above embodiment, application server 104 transmits charging request messages to OCS 120 for providing supplementary services much like the session control system 102 transmits charging request messages to OCS 120 for the session. As a result, the supplementary services may be charged separately from the session. Network operators thus have the flexibility to charge for supplementary services individually, which may lead to additional revenue for the network operators.

In FIG. 1, interface 108 comprises a Diameter Ro interface that is enhanced with new Attribute Value Pairs (AVPs) for supplementary services. When OCS 120 receives the charging request messages with the newly introduced supplementary service AVPs from application server 104, OCF 122 will know what supplementary services are involved and will use a newly introduced mechanism for supplementary service charging. If there is no supplementary service AVP present in Ro interface, then OCF 122 will charge the session as a normal session.

With the introduced supplementary service information, OCF 122 is enhanced in this embodiment to support the following charging modes for the supplement services. One charging mode is to charge the supplementary services with differentiate rates as the normal session. Another mode is to charge the different supplementary services with different rates. For example, a call forwarding charging rate is different than a call screening charging rate. Another mode is to charge the supplementary services as recurrent charge, non-recurrent charge, or usage charge based on the call time duration, traffic volume, number events, etc. Another mode is to charge additional parties for supplementary services with different rates. Another mode is to allocate credit slices for different parties involved in a session to session control system 102 and application server 104. For example, during a call forwarding call, Party A initiates the call, and application server 104 determines the party B wants to forward the call to his/her remote mobile number (Party C). OCS 120 receives the supplementary service AVPs from the application server 104, and determines that Party A is a prepaid subscriber and is responsible to charging leg I (A to B), determines that Party B is a fixed line subscriber and responsible to charging leg II (B to C), and determines that Party C is a prepaid mobile phone and is responsible for its own airtime. OCS 120 identifies the account information of parties A, B and C from ABMF 124, and transmits charging information to rating engine 126 to rate the call for the three parties. Then, OCS 120 issues the credit for three parties to application server 104 based on tariff and balances.

For the enhanced Ro interface 108, a new supplementary service AVP is defined as part of the “Service-Information” AVP. The new AVP may be termed “Supplementary-Service-Information”, although other names may be used. The Supplementary-Service-Information AVP includes information for charging for a supplementary service provided for a session. The Supplementary-Service-Information AVP is of type “Grouped” and may have the following ABNF grammar:

Supplementary-Service-Information :: =
{Service-Type }
[Service-Action]
[ Service-Mode]
[ Service-ID]
[ Associated-Number]
[ SS-Start-Time]
[ SS-Stop-Time]

The Service-Type AVP is of type “Enumerated” and indicates the supplementary service type. It is sub-AVP of the Supplementary-Service-Information AVP, and defines, for example, the following enumerated values:

Automatic Call Back (ACB)

Automatic Recall (AR)

Select Call Acceptance (SCA)

Call Transfer (TRANS)

Simultaneous Ringing (SIM)

n-Way Call (n-WAY)

Ring Back when Free (RBwF)

Customer Originating Call Trace (COT)

Call Park (PARK)

Call PickUp (PICKUP)

Authorization Code (AUTH)

Account Code (ACCT)

Flexible Call ID (FLXID)

Sequential Ringing (SEQ)

Carrier Pre-Selection (CPS)

MiRingBack (MRB)

Music On Hold (MOH)

Call Completion to Busy Subscriber (CCBS)

Multi-Level Precedence and Preemption (MLPP)

Customized Ring Back Tone (CRBT)

Abbreviate Dialing

The Service-Action AVP is of the type “Enumerated” and is sub-AVP of the Supplementary-Service-Information AVP. The Service-Action AVP defines, for example, the following enumerate values:

Activation

Deactivation

Invocation

Cancellation

The Service-Mode AVP is of the type “Enumerated” and indicates the supplementary service mode. It is sub-AVP of the Supplementary-Service-Information AVP, and defines, for example, the following enumerated values:

Call Forwarding Unconditional

Call Forwarding Default

Call Forwarding Busy

Call Forwarding Don't Answer

Call Forwarding Unregistered User

Call Forwarding Selective (for SCA and SCF)

Call Forwarding Sim Ring

Call Forwarding Local (e.g. SIP 302)

Call Transfer Blind

Call Transfer with Consultation

Call Transfer from N-way

Call Transfer Local (e.g. SIP Refer) User

Call Park—Park

Call Park—Retrieve

Call Park—Hold

Call Pickup—Pickup

Call Pickup—Directed Pickup

Call Pickup—Barge-In

N-Way—3 way call

N-Way—4 way call

N-Way—5 way call

N-Way—6 way call

Call Forwarding Sequential Ringing

Service-ID AVP is of type “UTF8String” and is a unique identifier for the supplementary service. Associated-Number AVP is of type “UTF8String” and indicates the number to invoke the supplementary service. SS-Start-Time AVP is of type “Time” and indicates the start time of the supplementary service. SS-Stop-Time AVP is of type “Time” and indicates a stop time of the supplementary service.

The Supplementary-Service-Information AVP allows for flexible charging tariffs for the supplementary services. In one example, different charging tariffs may be applied based on the supplementary service types. For instance, the charging tariff of call forwarding may be different from the charging tariff for the call transfer. In another example, different charging tariffs may be applied based on different service modes. For instance, for a call forwarding supplementary service, the charging tariff for call forwarding unconditional may be different from the charging tariff for call forwarding busy. In another example, different charging tariffs may be applied based on the different service actions. For instance, besides the normal supplementary service usage (e.g., 5 cents/minute for call forwarded session), there is an additional non-recurrent charge for supplementary service activation or deactivation (e.g., $3 to activate or deactivate the call forwarding supplementary service). In another example, different charging tariffs may be applied based on supplementary service start time and supplementary service stop time. For instance, from supplementary service start time to supplementary service stop time, OCS 120 may apply a recurrent charge (such as $2 per month for call barring supplement service).

The Supplementary-Service-Information AVP allows for a network operator to define the charging tariffs based on AVPs combination and other charging data to implement the more flexible supplementary service charging. For example, charging may be based on above any AVP combination. For instance, for network operator A, supplement service 1 is charged with a supplementary service usage rate (2 cents per minute), and with the additional re-current charge (such as $2 per month recurrent charge). For operator B, the supplement service is charged only a recurrent charge (such as $5 per month recurrent charge), but the normal supplement service usage in daily activity is free. In another example, charging may be based on the AVP and account profile promotional policy. For instance, the first 15 call barring services each month are charged as 10 cents/per service. After 15 call barring services, each call barring service is charged as 5 cents.

The Supplementary-Service-Information AVP allows the OCS to allocate additional charging parties for some of supplementary services. For example, with associated-number AVP and service modes, OCS 120 may find other responsible charging parties and check validity of their accounts. OCS 120 may also check charging tariffs for multiple parties in supplementary services. OCS 120 may also grant the quotas for multiple parties from their account balances to application server 104. If one or multiple parties cannot be authorized, (e.g., not a valid account or the balance is below a threshold) then OCS 120 may inform application server 104 to deny the supplementary service or the session.

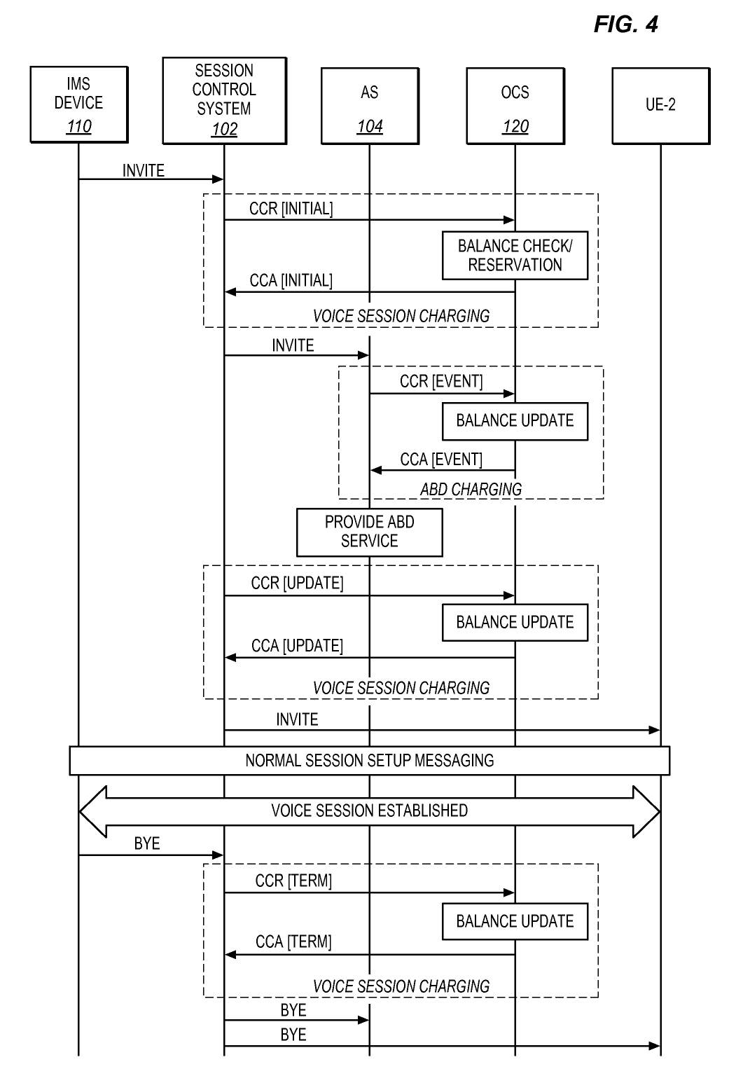

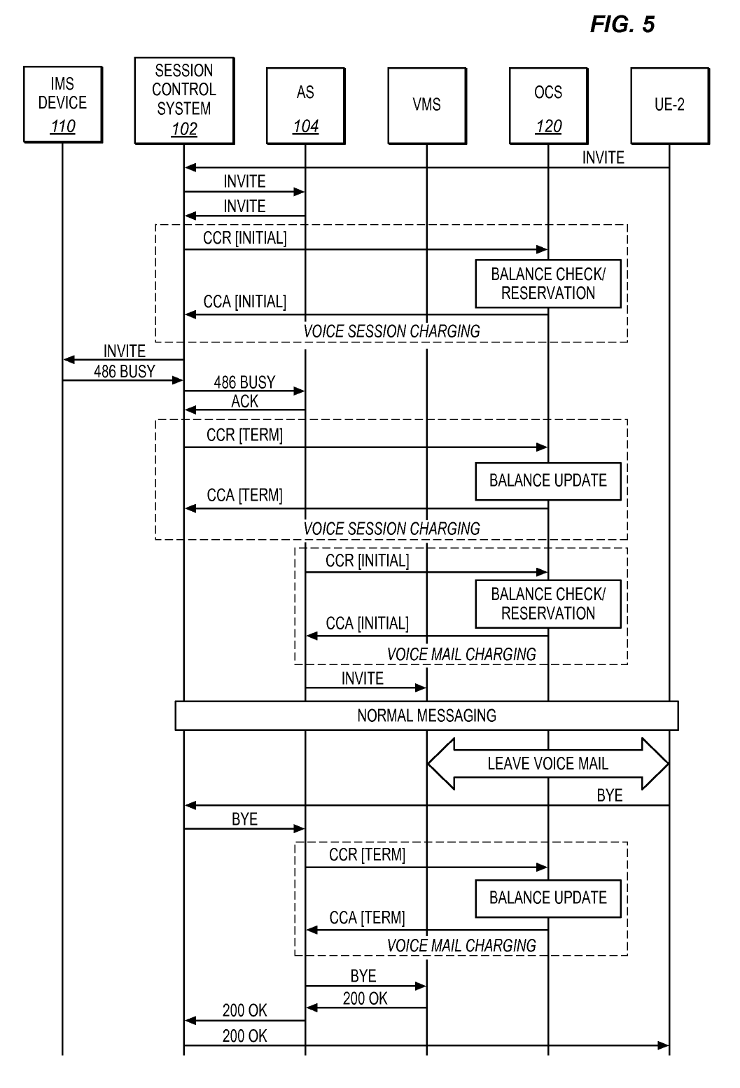

FIGS. 4-5 illustrate examples of charging for supplementary services in IMS network 100. FIG. 4 is a message diagram illustrating an example of Immediate Event service charging (IEC) for a supplementary service in an exemplary embodiment of the invention. In FIG. 4, assume that the user of IMS device 110 has subscribed to an abbreviated dialing (ABD) service which is provided by application server 104. The user of IMS device 110 creates a Tel URI with a local number which is set to the abbreviated dialing number. To initiate a voice session, IMS device 110 generates a SIP INVITE message with the Request URI set to the created Tel URI. IMS device 110 then transmits the INVITE message to session control system 102. Responsive to the INVITE message, the CTF in session control system 102 transmits a Diameter Ro CCR [INITIAL] message to OCS 120 to reserve a quota of service units based on the balance in the user's account. OCS 120 determines whether the user of IMS device 110 has enough service units in his/her account for the voice session. If the user's balance is sufficient, then OCS 120 responds with the granted quota in CCA [INITIAL] message to session control system 102.

Based on the initial filter criteria (IFC) defined for the user of IMS device 110, session control system 102 routes the INVITE message to application server 104. Upon receiving an INVITE message which includes the Tel URI having a local number and a “phone-context” parameter equal to the home network domain name, application server 104 determines that the voice session is intended for an abbreviated number. Before application server 104 attempts to convert the abbreviated number to the normal call number, application server 104 transmits a CCR [EVENT] message to OCS 120 to determine whether the user of IMS device 110 has enough service units in his/her account for the surcharge for the ABD service. If the user's balance in OCS 120 is insufficient for the ABD surcharge, then OCS 120 transmits a failed result in the CCA [EVENT] message back to session control system 102, and the voice session will be rejected. Based on the termination reason from the CCA [EVENT] message, application server 104 transmits a SIP 3xx/4xx/5xx to IMS device 110 with a corresponding error code.

If the user's balance is sufficient for the ABD surcharge, then OCS 120 updates the user's account to deduct the surcharge from the account in ABMF 124. OCS 120 also transmits a success result in the CCA [EVENT] message back to session control system 102. After receiving the successful return result, application server 104 provides the ABD service by mapping the local number in the received Request URI into the public user identity of the intended destination. Application server 104 also replaces the Request URI within the received INVITE with the mapping result. Application server 104 then transmits the INVITE message to session control system 102.

Responsive to the INVITE message, session control system 102 determines that the called party number has been changed (i.e., ABD number is translated to a normal directory number). Session control system 102 also transmits a Diameter Ro CCR [UPDATE] message to OCS 120 to re-authorize the granted service unit for IMS device 110. OCS 120 will re-authorize the credit control for IMS device 110 based on the received CCR [UPDATE] message, and transmits the granted service unit to session control system 102 in a CCA [UPDATE] message.

Session control system 102 then forwards the INVITE message to the intended destination, which is indicated as UE-2. IMS device 110 and UE-2 follow normal session setup messaging to establish the voice session. When established, session control system 102 will also perform normal online charging functions for the voice session.

When IMS device 110 ends the voice session, IMS device 110 transmits a SIP BYE message to session control system 102 to release the voice session. Responsive to the BYE message, session control system 102 transmits a Diameter Ro CCR [TERMINATION] message to OCS 120 to send the present charging for the voice session. OCS 120 deducts the charge from the user's account, and returns the granted service unit in a CCA [TERMINATION] message to session control system 102. Session control system 102 also transmits the BYE message to application server 104 and to UE-2.

Because both session control system 102 and application server 104 transmits CCR messages to OCS 120, there are two charges for this voice session. First, there is a charge for the ABD service (IEC). Second, there is a charge for the voice session (SBC). Thus, the ABD service is advantageously charged separate from the voice session.

FIG. 5 is a message diagram illustrating an example of Event-based charging with unit reservation (ECUR) for a supplementary service in an exemplary embodiment of the invention. Assume that a calling party (UE-2) wants to initiate a voice session with IMS device 110, which is busy on another session. To initiate the voice session, UE-2 generates a SIP INVITE message, and transmits the INVITE message to session control system 102. Based on the initial filter criteria (IFC) defined for the user of IMS device 110, session control system 102 routes the INVITE message to application server 104. The CTF in session control system 102 also transmits a Diameter Ro CCR [INITIAL] message to OCS 120 to reserve a quota of service units based on the balance in the user's account. OCS 120 determines whether the user of IMS device 110 has enough service units in his/her account for the voice session. If the user's balance is sufficient, then OCS 120 responds with the granted quota in CCA [INITIAL] message to session control system 102.

Session control system 102 then transmits the INVITE message to IMS device 110 to establish a voice session. In response to the INVITE message, IMS device 110 transmits a SIP 486 Busy Here message to session control system 102 indicating that that it is busy. Session control system 102 forwards the 486 Busy Here message to application server 104. Application server 104 then responds to IMS device 110 with a SIP ACK message. Responsive to the 486 Busy Here message, session control system 102 transmits a CCR [TERMINATION] message to OCS 120 to resolve charging on the user's account. OCS 120 responds with a CCA [TERMINATION] message.

Application server 104 determines that the user of IMS device 110 has subscribed to a voice mail deposit service. Application server 104 then sends a CCR [INITIAL] message to OCS 120 and sets supplementary service information AVP as the voice mail deposit. OCS 120 executes the ECUR for the voice mail deposit, and reserves the voice mail deposit surcharge from the user's account. OCS 120 then transmits a success result in a Diameter CCA [INITIAL] message back to application server 104.

Application server 104 optionally transmits a SIP 181 Call is Being Forwarded message to notify UE-2 that the voice session is being forwarded. Application server also transmits the INVITE message to a voice mail application server (VMS). UE-2 and the VMS exchange subsequent messages to establish a call to deposit the voice message. The user of UE-2 may then record a voice mail message in the voice mail box of IMS device 110.

When UE-2 finishes recording the voice mail message, UE-2 transmits a SIP BYE message to session control system 102 to release voice session. Session control system 102 forwards the BYE message to application server 104. Responsive to the BYE message, application server 104 transmits a CCR [TERMINATION] message to OCS 120 to inform OCS 120 that the mail deposit has ended. OCS 120 deducts the reserved VM deposit surcharge from the user's account, and returns a Diameter CCA [TERMINATION] to Application server 104. Application server 104 forwards the BYE message to the VMS, which responds with a SIP 200 OK message that is ultimately routed back to UE-2.

Because both session control system 102 and application server 104 transmits CCR messages to OCS 120, there are two charges for this voice session. First, there is a charge for the voice mail deposit service. Second, there is a charge for the voice session. Thus, the voice mail deposit service is advantageously charged separate from the voice session.

Although specific embodiments were described herein, the scope of the invention is not limited to those specific embodiments. The scope of the invention is defined by the following claims and any equivalents thereof.

We claim:

1. An IMS network adapted to provide online charging for supplementary services for a session, the IMS network comprising a session control system operable to receive at least one signaling message for the session, and to identify a trigger for a supplementary service to provide for the session, the IMS network further comprising:
an application server operable to provide the supplementary service for the session, to generate at least one charging request message for the supplementary service, and to transmit the at least one charging request message for the supplementary service to an online charging system (OCS) of the IMS network.

2. The IMS network of claim 1 further comprising:
the OCS comprising:
an online charging function;
an account balance management system operable to maintain an account for an IMS user involved in the session; and
a rating function operable to determine a cost of supplementary services.

3. The IMS network of claim 2 wherein:
the at least one charging request message from the application server to the OCS comprises an event-based charging request message;
the rating function is further operable to determine a rating for the supplementary service provided for the session when the rating function correlates the supplementary service with the session using the same IMS charging identifier; and
the account balance management system is further operable to debit the account for the IMS user based on the rating determined for the supplementary service.

4. The IMS network of claim 2 wherein:
the at least one charging request message comprises a session-based charging request message;
the rating function is further operable to determine a rating for the supplementary service provided for the session when the rating function correlates the supplementary service with the session using the same IMS charging identifier;
the account balance management system is further operable to grant a quota of service units based on the rating for the supplementary service; and
the online charging function is operable to generate a charging response message indicating the granted quota of service units for the supplementary service, and to transmit the charging response message to the application server.

5. The IMS network of claim 4 wherein the application server is further operable to:
receive the charging response message;
monitor usage of the granted quota of service units in providing the supplementary service; and
if the granted quota of service units expires, then transmit another charging request message to the OCS.

6. The IMS network of claim 1 wherein:
the charging request message comprises a Diameter message; and
the application server is further operable to:
identify charging information for the supplementary service; and
insert the charging information for the supplementary service in at least one new attribute value pair (AVP) of the Diameter message.

7. The IMS network of claim 6 wherein the at least one new AVP of the Diameter message indicates the type of supplementary service provided by the application server.

8. The IMS network of claim 6 wherein the at least one new AVP of the Diameter message indicates a timestamp for the supplementary service provided by the application server.

9. A method of providing online charging for supplementary services for a session in an IMS network, the method comprising:
providing a supplementary service for the session in an application server of the IMS network;
generating at least one charging request message for the supplementary service in the application server; and
transmitting the at least one charging request message for the supplementary service from the application server to an online charging system (OCS) of the IMS network.

10. The method of claim 9 wherein the at least one charging request message from the application server to the OCS comprises an event-based charging request message, the method further comprising:
determining a rating for the supplementary service provided for the session when the rating function correlates the supplementary service with the session using the same IMS charging identifier in the OCS; and
debiting the account for the IMS user based on the rating determined for the supplementary service.

11. The method of claim 9 wherein the at least one charging request message comprises a session-based charging request message, the method further comprising:
determining a rating for the supplementary service provided for the session when the rating function correlates the supplementary service with the session using the same IMS charging identifier;
granting a quota of service units based on the rating for the supplementary service; and
generating a charging response message indicating the granted quota of service units for the supplementary service; and
transmitting the charging response message from the OCS to the application server.

12. The method of claim 11 further comprising:
receiving the charging response message in the application server;
monitoring usage of the granted quota of service units in providing the supplementary service; and
if the granted quota of service units expires, then transmitting another charging request message from the application server to the OCS.

13. The method of claim 9 wherein the charging request message comprises a Diameter message, the method further comprising:
identifying charging information for the supplementary service; and
inserting the charging information for the supplementary service in at least one new attribute value pair (AVP) of the Diameter message.

14. The method of claim 13 wherein the at least one new AVP of the Diameter message indicates the type of supplementary service provided by the application server.

15. The method of claim 13 wherein the at least one new AVP of the Diameter message indicates a timestamp for the supplementary service provided by the application server.

16. An IMS network adapted to provide online charging for supplementary services for a session, the IMS network comprising:
an online charging system (OCS) operable to provide online charging for the session and at least one supplementary service for the session; and
an application server operable to provide the supplementary service for the session, to generate at least one charging request message for the supplementary service, and to transmit the at least one charging request message for the supplementary service to the OCS.

17. The IMS network of claim 16 wherein:
the at least one charging request message from the application server to the OCS comprises an event-based charging request message; and
the OCS is further operable to determine a rating for the supplementary service provided for the session when the rating function correlates the supplementary service with the session using the same IMS charging identifier, and to debit the account for the IMS user based on the rating determined for the supplementary service.

18. The IMS network of claim 16 wherein:
the at least one charging request message comprises a session-based charging request message; and
the OCS is further operable to determine a rating for the supplementary service provided for the session when the rating function correlates the supplementary service with the session using the same IMS charging identifier, to grant a quota of service units based on the rating for the supplementary service, to generate a charging response message indicating the granted quota of service units for the supplementary service, and to transmit the charging response message to the application server.

19. The IMS network of claim 18 wherein the application server is further operable to:
receive the charging response message;
monitor usage of the granted quota of service units in providing the supplementary service; and
if the granted quota of service units expires, then transmit another charging request message to the OCS.

20. The IMS network of claim 16 wherein:
the charging request message comprises a Diameter message; and
the application server is further operable to:
identify charging information for the supplementary service; and
insert the charging information for the supplementary service in at least one new attribute value pair (AVP) of the Diameter message.
